(19) United States
(12) Patent Application Publication
(10) Pub. No.: US 2013/0105591 A1
(43) Pub. Date: May 2, 2013

(54) DRIFT PLUME DISPLAY

(71) Applicant: John Peterson, Jackson, MN (US)

(72) Inventor: John Peterson, Jackson, MN (US)

(73) Assignee: AGCO CORPORATION, Duluth, GA (US)

(21) Appl. No.: 13/284,315

(22) Filed: Oct. 28, 2011

(51) Int. Cl. B67D 7/08

(52) U.S. Cl. 239/1; 239/71

(57) ABSTRACT

In one embodiment, a method implemented on a sprayer machine, the method comprising receiving weather information and sprayer machine information while the sprayer machine is in a field applying product; estimating a drift plume based on the weather and sprayer machine information; and providing for display a graphical representation of the estimated drift plume.

### TECHNICAL FIELD

The present disclosure is generally related to agricultural dispensing systems and, more particularly, computer-aided management of the dispensing of spray product.

### BACKGROUND

Agricultural sprayer systems in use today need to manage drift. Drift is a term used with crop protection, and generally refers to small droplets of solution containing chemicals mixed with water that do not attach to the target pest. Drift that leaves a target or target zone may have undesirable effects on non-target organisms, as well as air and water quality. The Environmental Protection Agency (EPA) has recently placed more focus on drift, drift control, and the definition of sensitive areas.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a plan view of an example sprayer machine with plural sensors corresponding to weather conditions and sprayer machine operation.

FIG. 1B is a schematic diagram of a rear end, elevation view of a portion of a sprayer machine that illustrates an example boom section of the sprayer assembly with various machine controls.

FIG. 2A is a block diagram of an example embodiment of a control system for a sprayer machine.

FIG. 2B is a block diagram of an example embodiment of an on-board computer system used in a control system for a sprayer machine.

FIG. 3 is an example screen diagram of an embodiment of an example graphical user interface (GUI) that is presented to an operator of a sprayer machine to illustrate an example drift plume.

FIG. 4 is an example screen diagram of an embodiment of an example GUI that is presented to an operator of a sprayer machine to illustrate an example drift plume relative to a graphic of the sprayer machine.

FIG. 5 is a flow diagram that illustrates an example embodiment of a method for displaying a drift plume on a sprayer machine.

### DESCRIPTION OF EXAMPLE EMBODIMENTS

### Overview

In one embodiment, a method implemented on a sprayer machine, the method comprising receiving weather information and sprayer machine information while the sprayer machine is in a field applying product; estimating a drift plume based on the weather and sprayer machine information; and providing for display a graphical representation of the estimated drift plume.

### DETAILED DESCRIPTION

Certain embodiments of drift plume display system and method for implementation on a dispensing machine, such as a sprayer machine, are disclosed. The drift plume display system provides a tool that presents to an operator a visual indication or representation (e.g., a graphical representation) of a drift cloud (herein, drift plume and drift cloud are used interchangeably) that is created by the sprayer machine as it advances through a field applying (e.g., dispensing or spraying) product. The product may include fluid product, solid product, and/or gaseous product, including pesticides, herbicides, fungicides, fertilizer, seeds, among other chemicals. The drift plume system receives weather information and/or sprayer machine information (e.g., navigation information, operating parameters for components of the sprayer assembly, etc.) from various sensors located on, or communicatively coupled to, the sprayer machine, and based on such information, estimates the drift plume (e.g., the coverage, e.g., in area or volume coordinates) and provides a visual representation of the estimated drift plume to an operator of the sprayer machine or other personnel. Such a visual representation may be in the form of a graphical representation, such as overlaid on a coverage map with or without a graphic representation of the sprayer machine. In some embodiments, the visual representation may be stored in a storage device (e.g., semiconductor, magnetic, or optical based media), and/or communicated (e.g., over a wireless network) to another device for storage and/or display.

In contrast to certain embodiments of drift plume display systems as disclosed herein, some conventional drift estimate or simulation software is static, implemented as a desktop solution without the benefit of real-time information of climatic and/or machine operating conditions that may alter the coverage of the drift plume. In other systems, real-time drift estimates may be estimated, without the benefit of enabling an operator to visualize the extent of the drift. For instance, an operator piloting a sprayer machine may experience changes in wind conditions that alter the amount or area location (e.g., concentration or intensity) of the drift plume, which given the length of certain sprayer assemblies (e.g., ninety-feet, end-to-end), hampers a proper understanding or appreciation of the scope of the drift and/or area coverage. Further, given the increased sensitivity by certain regulating bodies or other entities or individuals (e.g., concerned citizens) to chemicals and their impact on ground water supplies or in general, the safety and/or well-being of living organisms (e.g., humans, pets, etc.), lack of proper records pertaining to the as-applied product may result in legal issues later.

By providing a graphical representation of the drift plume, the operator is better informed of the scope of coverage of the sprayed product, and can also use such information for proper record keeping. For instance, such information may be communicated to others (e.g., farm management office, regulatory body) and/or stored locally (e.g., on a storage device) for evidence of coverage (or evidence of compliance).

Having summarized certain features of drift plume display systems of the present disclosure, reference will now be made in detail to the description of the disclosure as illustrated in the drawings. While the disclosure will be described in connection with these drawings, there is no intent to limit it to the embodiment or embodiments disclosed herein. For instance, in the description that follows, the focus is on pesticides as one example product that is applied to a field in an agricultural environment, but it should be appreciated within the context of the present disclosure that other types of product chemical or non-chemical applications for the agricultural industry or other industries are contemplated to be within the scope of the present disclosure. Further, although the description identifies or describes specifics of one or more embodiments, such specifics are not necessarily part of every embodiment, nor are all of the various stated advantages necessarily associated with a single embodiment. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

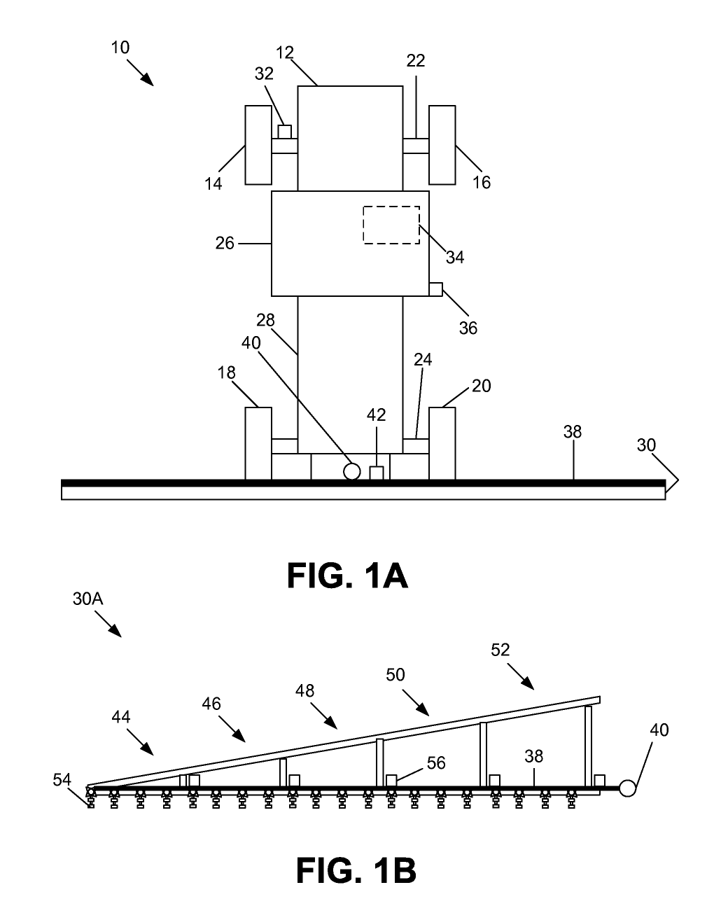

Reference is made to FIG. 1A, which illustrates an example sprayer machine 10 in which certain embodiments of a drift plume display system are implemented. One having ordinary skill in the art should appreciate in the context of the present disclosure that the example sprayer machine 10 is merely illustrative, and that other machines and/or components with like functionality may be employed in some embodiments. For instance, though depicted as a self-propelled machine, the sprayer machine may comprise a tractor towing a sprayer assembly (versus a self-propelled machine), or in some embodiments, the machine may be embodied as a tractor (or other type of machine, such as a truck, combine, etc.) towing another type of dispensing assembly, such as a pneumatic seed dispensers, or paint dispensing assembly, etc. In some embodiments, the self-propelled machine 10 may comprise of a different wheel and/or axle arrangement or design (e.g., where the dispensing assembly is located in the front of the sprayer machine, for instance). Reference to the term machine contemplates the collective towing/towed combination machines, self-propelled machines, and other types of machines for the dispensing of various product as described above, among others as should be appreciated by one having ordinary skill in the art in the context of the present disclosure. In one embodiment, the sprayer machine 10 comprises a front hood 12, wheels 14, 16, 18, and 20 (though tracts may be used in some embodiments), an axle assembly 22, 24 for pairs of front wheels 14, 16 and rear wheels 18, 20 respectively, a cab 26, a tank 28 which rests upon a chassis of the sprayer machine 10 and holds the product to be dispensed, and a sprayer assembly 30 coupled toward the rear of the sprayer machine 10 for dispensing the product to a field. Located underneath the front hood 12 is an engine, as is known. The axle assemblies 22 and 24 each provide a structure upon which the wheels mount, and further include sub-assemblies that enable the raising and lowering of the chassis, a brake sub-system, as well as a steering subsystem, as is known. The axle assembly 22 may further have attached thereto one or more sensors (e.g., sensor to provide sprayer machine information, such as navigation information), such as sensor 32, which provides an indication of whether or not the sprayer machine 10 is raised or lowered, the direction (e.g., via wheel angle sensor) the sprayer machine 10 is turning, and the speed. In some embodiments, a global positioning system residing on the sprayer machine 10 may achieve at least a portion of these functions, alone or in cooperation with the sensor 32. In some embodiments, the sensor 32 may be located elsewhere on the sprayer machine 10.

The cab 26 comprises an enclosure that protects the operator from environmental elements, and inside which an operator may interact with a computer system 34 to pilot the sprayer machine 10, as well as adjust and/or confirm settings for various sprayer machine controls. The computer system 34 is described in further detail below. Environmental sensors, such as sensor array 36, may comprise one or more sensors that, in one embodiment, are affixed to the cab 26 (e.g., outside) for sensing climatic conditions on a real-time basis. The sensor array 36 (herein, also referred to merely as sensor(s)) may be configured to measure temperature, humidity, barometric pressure, wind speed, wind direction, and/or wind turbulence. In some embodiments, the sensor array 36 may comprise sensors that are located elsewhere on the sprayer machine 10, localized in a single area or distributed in different areas of the sprayer machine 10.

The tank 28 comprises a containment vessel for holding the product to be applied to the field. Though described as a tank 28, other configurations for holding product are contemplated to be within the scope of the disclosure.

The sprayer assembly 30 comprises a boom (e.g., retractable and/or foldable in some embodiments, with one or a plurality of pieces) that supports one or more conduits, such as hose 38, which conveys the product along the length of the sprayer assembly 30 for dispensing of the same to the field. For instance, the sprayer assembly 30 may include one or more pumps, such as pump 40, coupled to the hose 38 to influence the flow of product from the tank 28 to nozzles located along the boom. The pump 40 may have an integrated sensor (e.g., pressure sensor). In some embodiments, one or more sensors, such as sensor 42, may be disposed near the pump 40 (or elsewhere) and positioned to measure the product pressure flowing through the hose 38, product flow, and/or product temperature. Additional pressure sensors may be disposed along the length of the hose 38 in some embodiments.

It should be appreciated that some of the conduits may also be used for the conveyance of control fluids (e.g., hydraulic or pneumatic fluids) and/or electricity, such as that used to actuate (e.g., actuate used herein to refer to the adjustment of settings, as well as activation or de-activation of the controlled device) certain sprayer machine controls, including actuators (internal or external to the controlled device) used to turn on and off boom sections, select nozzle types, control pump speeds, actuate valves, among other functions.

FIG. 1B shows a more detailed, elevation view of a left rear portion of the sprayer assembly 30, denoted as sprayer assembly 30A, which in one embodiment comprises a tubular, truss-like structure with plural, independently controllable boom sections 44, 46, 48, 50, and 52, with the hose 38 conveying product to be applied to the field as influenced by the pump 40. Each boom section, such as boom section 44, comprises one or more nozzles, such as nozzle 54 (or nozzle group). As is known, a nozzle generally has essentially two functions: to meter the amount of product (e.g., liquid) that can be sprayed and to create a spray pattern. In an effort to minimize drift, nozzles have been designed to optimize the size of the drop that is sprayed from the nozzle. Two such nozzle types are pre-orifice and turbulation type nozzles. In the pre-orifice nozzle, the two functions (volume and pattern) are separated between two orifices. The first orifice controls the flow into the nozzle and the second orifice controls the spray pattern. This reduces pressure on the liquid as it exits the nozzle resulting in larger drops and thus less drift. In the turbulation type nozzle, a chamber is provided which provides room for the liquid to expand prior to exiting the nozzle. This lowers the pressure behind the liquid that exits the nozzle, thus creating larger drops and less drift. One type of pre-orifice nozzle is an air-atomizing nozzle. This is a nozzle that draws air into the liquid through a carburetor-like venture. The air and liquid pass through a mixing chamber and are sprayed out together. By introducing air, the nozzle is capable of producing larger drops, which results in less drift. The computer system 34 may automatically adjust the drop size in real-time or substantially real-time using such technology. In some embodiments, the nozzle 54 may be configured with a rotatable actuator (a nozzle control that is mechanically or electrically actuated) which enables automated selection (e.g., by the computer system 34) of a nozzle type among a selectable group of nozzles at each nozzle location. For instance, each nozzle 54 of a given group, at a given location along the boom, may differ in nozzle performance, such as flow pattern, or be distinguished based on the type of product to flow therethrough. In some embodiments, a single nozzle may achieve functionality of different types of nozzles through the manner of control of the fluid, as is known.

Note that in embodiments using different dispensing assemblies (e.g., different than sprayer assemblies), the nozzles may be replaced with other components, such as orifices, etc.

In some embodiments, each section 44-52 may have an associated actuator, such as actuator 56, which enables selective actuation (or disablement, such as via the computer system 34) of an associated boom section 44-52. In some embodiments, a single actuator may be used (coupled to the sprayer assembly 30 or otherwise) with multiple contacts to enable control of all sections 44-52. Other known mechanisms of enabling individual nozzle and/or boom section control are contemplated to be within the scope of the disclosure, and hence further explanation of the same is omitted here for brevity.

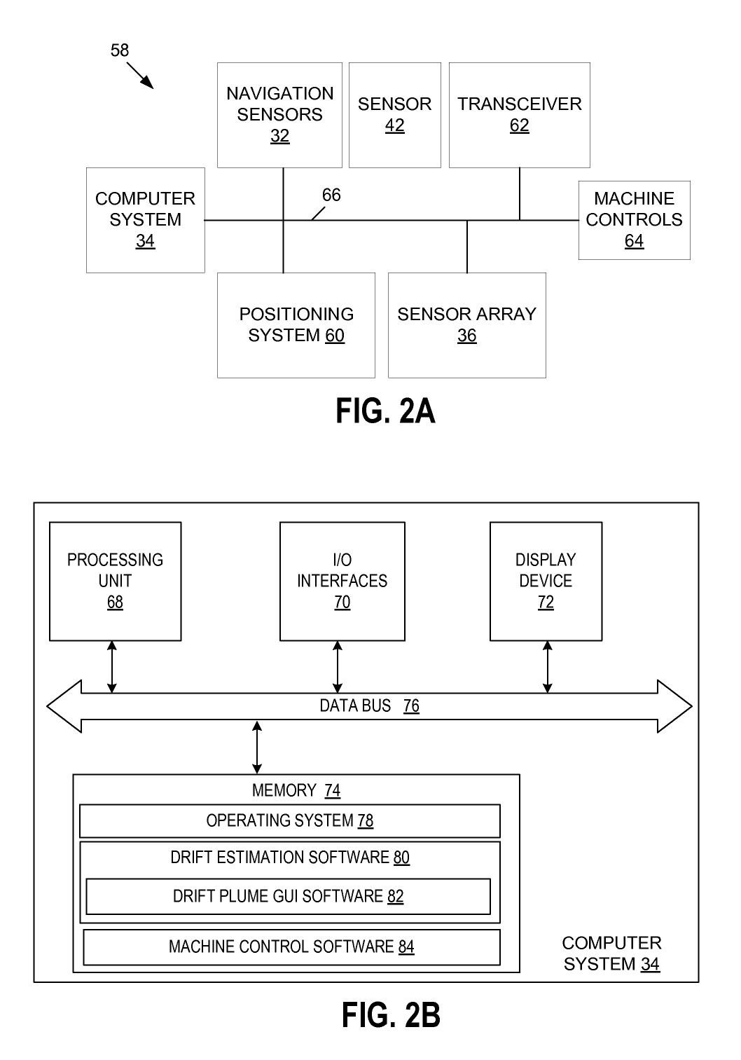

Attention is now directed to FIG. 2A, which illustrates an embodiment of a control system 58. In one embodiment, a drift plume display system includes all of the components of the control system 58. Some embodiments of a drift plume display system may embody a subset of the components illustrated in FIG. 2A, or additional components in some embodiments. One having ordinary skill in the art should appreciate in the context of the present disclosure that the example control system 58 is merely illustrative, and that some embodiments of control systems may comprise fewer or additional components, and/or some of the functionality associated with the various components depicted in FIG. 2A may be combined, or further distributed among additional components, in some embodiments. In one embodiment, the control system 58 comprises the computer system 34 and a plurality of coupled sensors, such as the sensor(s) 32 (e.g., providing sprayer machine information, including navigation information such as sprayer machine speed, direction, pitch, chassis elevation, etc.), the environmental sensor array 36 (e.g., providing weather information), and the sensor(s) 42 (e.g., providing sprayer machine information, such as operating parameters of components of the sprayer assembly 30, including product pressure, temperature, flow, etc.). The environmental sensor array 36 comprises one or more sensors that detect climatic conditions in the field, including real-time wind speed, wind direction, turbulence, outdoor temperature, barometric pressure, humidity, etc. In some embodiments, the environmental sensor array 36 may be omitted, and weather information may be communicated to the computer system 34 by field stations (e.g., weather sensors located in the field) or other machines in the field.

The control system 58 further includes a positioning system (e.g., global positioning system (GPS), geographic information system (GIS), etc.) 60, a transceiver 62 (e.g., transceiver logic), and machine controls 64, all coupled over a network 66, such as a controller area network (CAN), though not limited to a CAN network or a single network. In some embodiments, the positioning system 60 may be used in place of all or a subset of the sensors 32, and in some embodiments, one or more of the sensors 32 may supplement (or replace in some embodiments) the functionality of the positioning system 60. The positioning system 60 enables the detection of a geofence (e.g., stationary or moving), as well the detection of vehicle positioning (e.g., of the sprayer machine 10 or other machines in the field), detection of sensitive areas (e.g., buffer areas or zones or setbacks where product application is to be avoided, and which may be defined by a geofence), and topographic boundaries and/or attributes, etc. In some embodiments, radar logic may be used to assist in the topographical assessment of a given field. In one embodiment, the positioning system 60 enables the computer system 34 to derive a coverage map for presentation to the operator, the coverage map providing a topology of the field in which the product is to be applied. The coverage map provides a real-time view of the field as the operator pilots the sprayer machine 10 across the field. In some embodiments, a graphical representation of the sprayer machine 10 may also be presented relative to the coverage map.

The machine controls 64 include navigation subsystems (e.g., controllers that control steering subsystems, chassis elevation, speed, direction, height, etc.) to control the sprayer machine 10 as it traverses a field. The machine controls 64 also include sprayer assembly controls, such as the actuators 56, actuators of the nozzles 54, valve and/or valve actuators, solenoids, pumps 40, etc. In other words, the machine controls 64 collectively represent the various actuators and/or controlled devices residing on the sprayer machine 10, including those used to control machine navigation and sprayer functionality, including pumps, valves, meters, nozzles, boom sections, boom height controls, vehicle navigation (e.g., steering subsystems, engine/drivetrain, etc.), vehicle height controls, drift control products, among others. Note that in some embodiments, one or more of the aforementioned control components may be omitted, or functionality of one or more of the components may be combined. In some embodiments, the control system 58 may include additional components.

The transceiver 62 enables the communication of information with other devices, including remote devices (e.g., laptops, computer systems, etc.) for receiving image information pertaining to any graphical representations of a drift plume, among other information. Communication may include telephonic, wireless data, among other types of information conveyance. In other words, the transceiver 62 enables communication with other networks, such as locally or via a network to a remote location. As a non-limiting example, the transceiver 62 may include a modulator/demodulator (e.g., a modem), wireless (e.g., radio frequency (RF)) transceiver, a telephonic interface, among other network components.

The computer system 34 receives and processes the information from the sensors 32, 42, 36 and the positioning system 60, executes drift estimation software, and presents an estimate of a drift plume to the operator in the form of a graphical representation. FIG. 2B further illustrates an example embodiment of the computer system 34. One having ordinary skill in the art should appreciate in the context of the present disclosure that the example computer system 34 is merely illustrative, and that some embodiments of computer systems may comprise fewer or additional components, and/or some of the functionality associated with the various components depicted in FIG. 2B may be combined, or further distributed among additional modules, in some embodiments. Certain well-known components of computer systems are omitted here to avoid obfuscating relevant features of the computer system 34. In one embodiment, the computer system 34 comprises one or more processing units 68, input/output (I/O) interface(s) 70, a display device 72, and memory 74, all coupled to one or more data busses, such as data bus 76.

The memory 74 may include any one of a combination of volatile memory elements (e.g., random-access memory RAM, such as DRAM, and SRAM, etc.) and nonvolatile memory elements (e.g., ROM, hard drive, tape, CDROM, etc.). The memory 74 may store a native operating system, one or more native applications, emulation systems, or emulated applications for any of a variety of operating systems and/or emulated hardware platforms, emulated operating systems, etc. In the embodiment depicted in FIG. 2B, the memory 74 comprises an operating system 78 and drift estimation (or similarly, drift prediction or drift simulation software) software 80 that in one embodiment comprises drift plume display graphical user interface (GUI) software 82. The memory 74 further comprises machine control software 84 to provide control signals to various machine controls 64. In some embodiments, actuation signals may be sent to the machine controls 64 via the drift estimation software 80 without the intervention of the machine control software 84. It should be appreciated that in some embodiments, additional or fewer software modules may be employed in the memory 74 or additional memory. In some embodiments, a separate storage device may be coupled to the data bus 76, such as a persistent memory (e.g., optical, magnetic, and/or semiconductor memory and associated drives).

The drift estimation software 80 comprises functionality to alter the size of the droplets of the product applied to the field based on real-time (or near-real-time) weather and/or sprayer machine information. By altering the droplet size on a continuous or periodic basis (or responsive to a threshold event, such as the exceeding of the drift plume beyond a certain targeted coverage area), the drift plume can be managed. In one embodiment, the operator may be presented (via the drift plume display GUI software 82) a GUI that enables the operator to receive input from the operator as to what type of optimal drop size is desired. The drift plume display GUI software 82 may present to the operator on the display device 72 a graphical representation of the drift plume based on a default value (e.g., default droplet size), which is adjusted once real-time weather and/or sprayer machine information is received (or in some embodiments, adjusted at a threshold interval of time afterwards). In some embodiments, the choice of the optimal droplet size may be visually represented by changes on the displayed graphical representation of the drift plume, where the operator may obtain a visual confirmation of the appropriate droplet size by how it affects the drift plume. In some embodiments, the operator may utilize a drag-and-drop function whereby a corner of the graphical representation of the drift plume is “dragged” (e.g., using a mouse, touchscreen, etc.) by the operator and expanded or retracted as desired by the operator, which causes the drift estimation software 80 to re-calculate the droplet size and then signal the appropriate machine controls 64 to make adjustments to the droplet size to meet the desired drift plume.

The operator may be given a choice of maximizing the drift, minimizing the drift or maintaining the drift within a specific range. As the sprayer machine 10 traverses the field applying product to the field, the processing unit 68 receives, from one or more of the sensors 32, 42, 36, information about the current conditions that may affect the drift of the sprayed product (e.g., affect the drift plume). A graphical representation of the drift plume may continue to be displayed on a screen of the display device 72. Note that while the drift estimation software 80 may be configured to determine many factors that may affect the drift plume, it is conceivable and thus within the scope of the present disclosure that not all of the measurements will necessarily be employed in every determination of optimal drop size. While all of the measurements may be employed, for various reasons, it may be more efficient to only use a subset of the measurements to determine the optimal drop size. The choice to use only a subset of the measurements may be a design choice that is provided to the operator or it could be programmed into the drift estimation software 80 based on certain conditions. For example, if certain measurements fall within a defined range, the drift estimation software 80 may be designed to ignore such measurements in the next calculation of optimal drop size, for a set period of time, or the drift estimation software 80 may be programmed to ignore such measurement for the duration of the current spray.

Once the weather and/or sprayer machine information is received from one or more of the sensors 32, 42, 36, the processing unit 68 executes the drift estimation software 80 to determine an optimal drop size for the current conditions. Those skilled in the art should recognize that optimal drop size may be different for different operations. For example, optimal drop size may be determined to minimize drift in the case of harmful pesticides, or it may be determined to maximize or increase drift in the case of fertilizer or some other beneficial chemical for hard to reach or stubborn areas.

The drift estimation software 80 compares the optimal drop size to the current drop size. The equations required to calculate flow rate, drop size and drift are well known as are the tables that show spray volumes for various nozzles and thus will not be reproduced herein. In the event that the sprayer machine 10 has not yet begun spraying, it is within the scope of the disclosure that there may be a default value for the initial drop size, or the first calculation of optimal drop size may be employed to set the initial drop size, or selected based on corresponding drift plumes displayed on a screen of the display device 72. If the sprayer machine 10 is in operation, the drift estimation software 80 compares the calculated optimal drop size to the current drop size and determines if they are identical or within an acceptable range. If the current drop size is the same as, or within, the acceptable range as the optimal drop size, the drift estimation software 80 recalculates the optimal drop size based on the current sensor information. Those skilled in the art should recognize that these sensor readings may be continuous or periodic or based on a threshold event as described above. In one embodiment, the calculations are periodic as conditions may not fluctuate greatly on a continuous basis.

If the drift estimation software 80 determines that the current drop size is not the same as or falls outside of an acceptable range, the drift estimation software 80 determines whether the drop size needs to be increased or decreased. To increase the size of the drop, the drift estimation software 80 (alone, or in cooperation with the machine control software 84) sends a signal to the machine controls 64 (e.g., to the pump 40 or an actuator associated with the pump 40) to decrease the pressure of the sprayed product, thus increasing the size of the drop. In some embodiments, the signal to the machine controls 64 may be directed to the actuator of the nozzle 54, such as to change a nozzle type to another type (e.g., rotation to another nozzle within a nozzle group). In some embodiments, depending on the type of nozzle 54 employed, the pressure drop may be achieved by decreasing air pressure, increasing or decreasing (depending on the location and purpose of the aperture) one or more apertures of the nozzle 54 and/or increasing the volume of a chamber in the nozzle 54. Decreasing the air pressure is self-explanatory. Increasing or decreasing an aperture may be achieved in any number of conventional ways. For example, actuators (e.g., included as machine controls 64), such as servo motors, solenoids or the like may be employed to cause an object such as a conical shaped rod, a cylindrical rod or some other shaped rod to move in or out of the aperture or to place some other form of impediment across a portion of the aperture.

Conversely, to decrease the size of the drop the drift estimation software 80 (alone, or in cooperation with the machine control software 84) may send a signal to the machine controls 64 (e.g., to the pump 40 or an associated actuator) to increase the pressure of the sprayed product, thus decreasing the size of the drop. Depending on the type of nozzle 54 employed, this pressure increase may be achieved by increasing air pressure, decreasing or increasing one or more apertures of the nozzle 54, and/or decreasing the volume of a chamber in the nozzle 54 (or in some embodiments, a different nozzle type may be rotated in, as described above). This may be achieved by using the methods described in connection with increasing the drop size in reverse. Once the drop size is adjusted, the drift plume display GUI software 82 adjusts the graphical representation of the drift plume (e.g., decreasing or increasing the area of coverage by the drift plume, depending on the size of the droplet).

As another illustration, various obstacles defined by a respective geofence may change over time, resulting in adjustments in the sprayer machine 10 navigational path and/or application plan. For instance, a hazard or area where application of product is to be avoided at one time period may become benign for purposes of product application at other time periods. For instance, during the rainy season, a given geofence area pertaining to a body of water may correspond to one size (e.g., area), and in the dry season, the body of water may have dissipated in size or completely disappeared. Or as another example, a support machine may approach the sprayer machine 10, causing a detection of a geofence (via the positioning system 60) that is unanticipated. In these or other instances of geofence changes, adjustments may be made to one or more controls corresponding to sprayer machine navigation or product dispensing (e.g., to compensate for the changed geofence, such as to avoid an incoming hazard). For instance, the boom height may be raised to avoid a hazard (and/or a section of the boom that normally would have been deactivated is now activated, or vice versa), and/or the sprayer machine 10 may alter the direction (e.g., make a closer pass to a given changed geofence) based on the ability to encroach on a previously sensitive area (e.g., an area that previously contained a body of water), since the risk of damage due to drift is lowered. In addition, due to (e.g., responsive to) such adjustments in control, the drift estimation software 80 may re-calculate (e.g., in real time) the drift plume (e.g., to change the boundaries of the drift plume), and the drift plume GUI software 82 may represent this changed drift plume boundary on the screen 88. One having ordinary skill in the art should understand, in the context of the present disclosure, that other scenarios are contemplated that may result in adjustments in various sprayer machine controls and hence adjustments to the drift plume and corresponding graphical display.

Execution of the software modules 82 and 84 are implemented by the processing unit 68 under the auspices of the operating system 78. The processing unit 68 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the computer system 34.

The I/O interfaces 70 provide one or more interfaces to the network 66, as well as interfaces for access to computer readable mediums, such as memory drives, which includes optical, magnetic, or semiconductor-based drives. In other words, the I/O interfaces 70 may comprise any number of interfaces for the input and output of signals (e.g., analog or digital data) for conveyance over the network 66 and other networks. For instance, the output comprises output signals (e.g., actuation signals, signals pertaining to the adjustment of settings, actuation of a given controlled device, etc.) for reception by one or more of the components of the control system 58, such as the machine controls 64. The input may comprise input by an operator through a keyboard or mouse (or audible input in some embodiments, or touch screen at the display device 72), and input from signals carrying information from one or more of the components of the control system 58, such as from sensors 32, 42, and 36. Other devices, such as audible alarms, warning lights, etc. may be controlled through the I/O interfaces 70.

The display device 72 comprises one of a variety of types of displays, including liquid crystal diode (LCD), among others, that provide an outputted GUI to the operator as indicated above. In some embodiments, the display device 72 may comprise known touch-screen technology for the entering of inputs by the operator.

To the extent certain embodiments of the computer system 34 (or one or more of its constituent components) are implemented at least in part in logic configured as software/firmware (e.g., executable code), as depicted in FIG. 2B, the logic can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program for use by or in connection with a computer-related system or method. The logic may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

To the extent certain embodiment of the computer system 24 (or one or more of its constituent components) are implemented at least in part in logic configured as hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

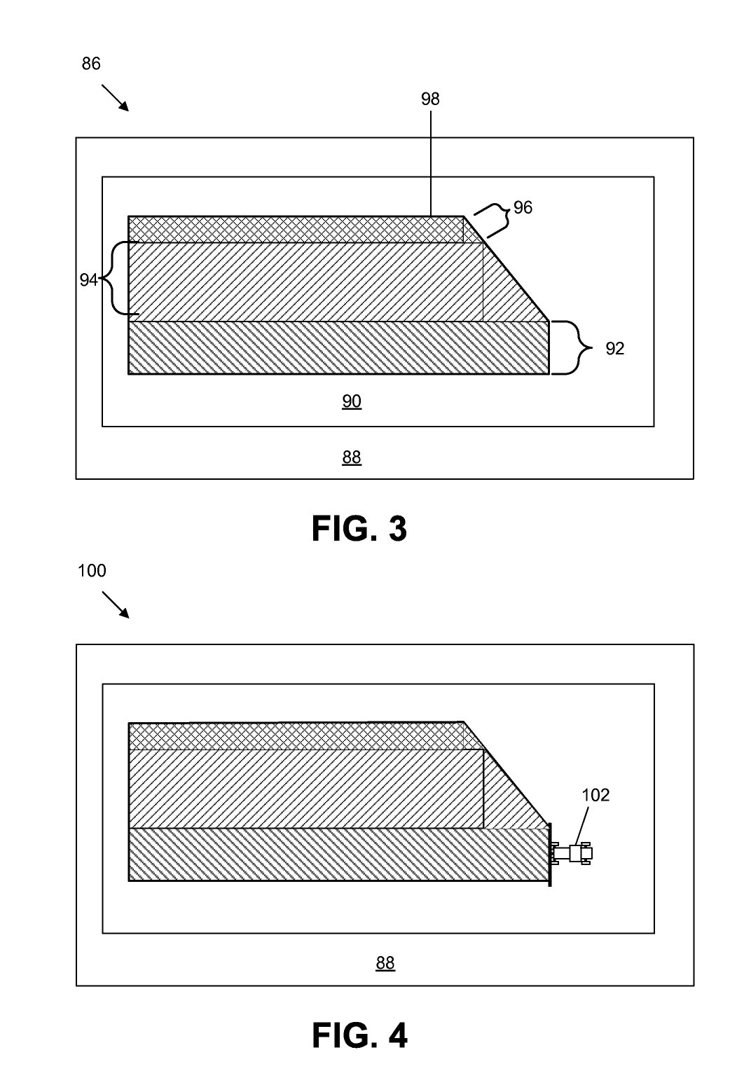

Attention is now directed to FIG. 3, which shows an example embodiment of a GUI 86 presented on a screen 88 of the display device 72. One having ordinary skill in the art should appreciate in the context of the present disclosure that the example GUI 86 is merely illustrative, and that in some embodiments, other formats or visual arrangement may be used to convey the drift plume. As described above, in one embodiment, the GUI 86 is presented on the screen 88 by the drift plume display GUI software 82. The GUI 86 comprises a background 90 representing the field. Such a background 90 may be an image of the field or a graphical representation of the field, with or without certain attributes pertaining to the topography of the field. The GUI 86 further comprises various areas representing the drift plume of the applied product (e.g., sprayed from the sprayer machine 10), including areas 92 (represented with diagonal lines from top-left to lower right), 94 (represented with diagonal lines from bottom-left to top right), and 96 (represented with diagonally-crossed lines). The areas 92, 94, and 96 graphically represent the drift plume in differing degrees of applied concentration or intensity. For instance, assume for this example that travel of the sprayer machine is from left-to-right in FIG. 3, and that the wind direction is from bottom to top of the figure, and the width of the sprayer assembly 30 corresponds to area 92. The area 92, which represents the drift plume directly beneath the spray nozzles 54 (and as applied in the same areas in the immediately preceding pass) of the sprayer assembly 30, has a greater intensity or concentration of sprayed product (e.g., there is more amounts of sprayed product to be applied to the field) than the area 94 (drift plume portion offset from directly underneath the sprayer nozzles due to the wind), which has a greater intensity of concentration than the area 96 (the drift plume reaching the farthest away from the sprayer machine 10 due to the wind in this example). In other words, the areas 92, 94, and 96 are graphical representations of the estimated drift plume (e.g., as estimated by the drift estimation software 80, as described above). Each of these areas 90, 92, 94, and 96 may be visually distinguished by color, shading, or texture or other graphical mechanisms, such as a common color or shading with different overlaid data corresponding to the amount or concentration of the drift plume.

Note that exacting lines of FIG. 3 (and FIG. 4) are used to illustrate the various boundaries, where it should be appreciated that other, more random or realistic looking lines may be presented in some embodiments to more accurately depict the actual area boundaries or scope of the plume. For instance, in some embodiments, the actual drift plume may be more realistically represented on the screen 88, conveying more irregular boundaries (e.g., outside and internal concentration boundaries). That is, the displayed graphical representations of the evolving drift plumes are contemplated as being presented in a dynamic and ever-evolving display, with the displayed, graphical drift plume depictions or representations dynamically varying (e.g., in real time or near real time, or in some embodiments, in snapshots separated by a defined or configurable interval of time) in intensity and area as the concentration varies and as the weather and/or machine movement changes. For instance, the displayed, graphical representations of the drift plumes may aggregate over several passes, resulting in different areas of concentration. Also, the displayed graphical representation of the drift plumes may depict the fading of the drift plume from an earlier pass as the sprayer machine 10 advances in time and/or distance over the field while depicting the more recent drift plume concentrations as more dominant in appearance.

Note that fewer or greater amounts of areas may be used for distinction. For instance, the outside perimeter line 98 may be the only graphical element used to represent the plume, or in some embodiments, the line 98 may be used along with data pertaining to environmental conditions and/or sprayer machine parameters) as a simple way of illustrating the boundaries of coverage of the sprayed product (e.g., the maximum reach or trajectory of the sprayed product). In some embodiments, the outside perimeter line 98 may be omitted. In some embodiments, a greater number of distinct regions may be used to provide a further indication or resolution of the amount of sprayed product, for instance where product was overlapped such as during turns or due to the drift. In some embodiments, as indicated above, additional information may be included on the screen 88, such as wind direction, wind speed, turbulence, sprayer machine speed, sprayer machine direction, etc.

FIG. 4 shows another example embodiment of a GUI 100 presented on the screen 88 of the display device 72. One having ordinary skill in the art should appreciate in the context of the present disclosure that the example GUI 100 is merely illustrative, and that in some embodiments, other formats or visual arrangement may be used to convey the drift plume. This example GUI 100 is similar to the GUI 86 except with a graphical representation 102 (plan view) of the sprayer machine 10 included. In some embodiments, other views (e.g., angles, perspectives, etc.) may be used, with or without additional (or less) information.

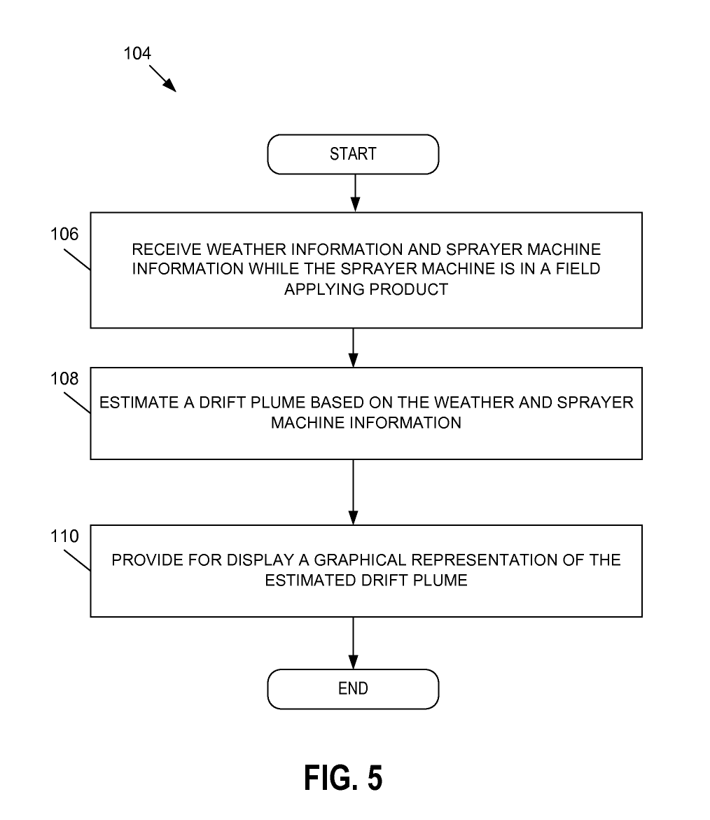

In view of the above description, it should be appreciated that one embodiment of a drift plume display method implemented on a sprayer machine 10, as depicted in FIG. 5 and denoted as method 104, comprises receiving weather information and sprayer machine information while the sprayer machine is in a field applying product (106); estimating a drift plume based on the weather and sprayer machine information (108); and providing for display a graphical representation of the estimated drift plume (110).

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. A method implemented on a sprayer machine, the method comprising:
receiving weather information and sprayer machine information while the sprayer machine is in a field applying product;
estimating a drift plume based on the weather and sprayer machine information; and
providing for display a graphical representation of the estimated drift plume.

2. The method of claim 1, wherein receiving the weather information comprises receiving one or any combination of wind speed, wind direction, wind turbulence, temperature, humidity, or barometric pressure.

3. The method of claim 1, wherein receiving the weather information comprises receiving the weather information from sensors attached to the sprayer machine, field sensors, or a combination of both.

4. The method of claim 1, wherein receiving the sprayer machine information comprises receiving navigation information of the sprayer machine and operating parameters of components of a sprayer assembly coupled to the sprayer machine.

5. The method of claim 4, wherein receiving the navigation information comprises receiving one or any combination of speed, direction, or pitch of the sprayer machine.

6. The method of claim 4, wherein receiving the operating parameters comprises receiving one or a combination of pressure of the product or nozzle type.

7. The method of claim 1, wherein providing for display comprises providing the graphical representation of the drift plume relative to a graphic of the sprayer machine.

8. The method of claim 1, wherein providing for display comprises overlaying the graphical representation of the drift plume on a coverage map of the field.

9. The method of claim 1, wherein providing for display comprises providing distinct regions in the graphical representation based on density of the drift plume.

10. The method of claim 1, further comprising communicating an image of the graphical representation of the estimated drift plume to a remote device, storing an image of the graphical representation of the estimated drift plume to a storage device, or a combination of both.

11. A system implemented on a machine, the system comprising:
a memory comprising executable code; and
a processor configured by the executable code to:
receive real-time weather information and machine information while the machine is in a field;
estimate a drift plume dispensed from the machine based on the weather and machine information; and
provide for display a graphical representation of the estimated drift plume.

12. The system of claim 11, further comprising one or more sensors configured to provide information corresponding to one or any combination of wind speed, wind direction, wind turbulence, temperature, humidity, or barometric pressure to the processor.

13. The system of claim 11, wherein the processor is further configured by the executable code to receive navigation information of the machine and operating parameters of components of a dispensing assembly coupled to the machine.

14. The system of claim 13, further comprising one or more sensors configured to provide the navigation information to the processor, the navigation information comprising one or any combination of speed, direction, or pitch of the machine.

15. The system of claim 13, further comprising one or more sensors configured to provide the operating parameters to the processor, the operating parameters comprising one or a combination of pressure of the product or nozzle type.

16. The system of claim 11, further comprising a display device, wherein the processor is further configured by the executable code to provide on a screen of the display device either the graphical representation of the drift plume relative to a displayed graphic of the machine or an overlay of the graphical representation of the drift plume on a displayed coverage map of the field.

17. The system of claim 11, further comprising a display device, wherein the processor is further configured by the executable code to provide on a screen of the display device a default drift plume, and responsive to receiving user input corresponding to alterations on the screen of coordinates of the default drift plume, calculating a target droplet size based on the altered coordinates of the default drift plume.

18. The system of claim 11, further comprising a display device, wherein the processor is further configured by the executable code to provide on a screen of the display device distinct regions in the graphical representation based on density of the drift plume.

19. The system of claim 11, further comprising transceiver logic, wherein the processor is further configured by the executable code to cause the transceiver logic to communicate an image of the graphical representation of the estimated drift plume to a remote device, wherein the processor is further configured by the executable code to store an image of the graphical representation of the estimated drift plume to a storage device or the memory.

20. A machine, comprising:
a dispensing assembly comprising a plurality of components configured to dispense product to a field;
a plurality of sensors configured to receive real time weather information and machine information, the machine information comprising navigation information and information pertaining to performance of the plurality of components;
a display device comprising a screen; and
a computer system configured to:
receive the real-time weather information and the machine information from at least a portion of the plurality of sensors while the machine is operating in a field;
estimate a drift plume based on the weather and machine information; and
provide on a screen of the display device a graphical representation of the estimated drift plume.

21. The machine of claim 20, wherein the computer system is further configured to re-estimate the drift plume based on a change in a geofence in the field.

22. The machine of claim 21, wherein the computer system is further configured to provide on the screen a graphical representation of the re-estimated drift plume based on the changed geofence.

23. The machine of claim 22, wherein the graphical representation of the re-estimated drift plume has a different boundary than the graphical representation of the estimated drift plume.

24. The machine of claim 23, wherein the boundary is different based on weather conditions, machine movement, or a combination of both.

25. The machine of claim 23, wherein the computer system is further configured to cause adjustments in controls for the dispensing assembly, navigation, or a combination of both.

26. The machine of claim 25, wherein the controls for the dispensing assembly comprise boom section control, boom height control, or a combination of both.
